(19) United States
(12) Patent Application Publication
(10) Pub. No.: US 2014/0078653 A1
(43) Pub. Date: Mar. 20, 2014

(54) ENCLOSURE OF ELECTRONIC DEVICE WITH CUSHION PAD

(71) Applicant: HON HAI PRECISION INDUSTRY CO., LTD., New Teipei (TW)

(72) Inventors: PO-CHING CHIANG, New Taipei (TW); LUN-FENG LIAO, New Taipei (TW); CHI-TSE SHIH, New Taipei (TW)

(21) Appl. No.: 13/921,369

(22) Filed: Jun. 19, 2013

(30) Foreign Application Priority Data
Sep. 14, 2012 (TW) 101133616

(51) Int. Cl. G06F 1/16

(52) U.S. Cl. CPC G06F 1/1613
USPC 361/679.01; 206/521

(57) ABSTRACT

An enclosure of an electronic device includes a case and a cushion pad. The case includes a bottom plate defining a receiving slot and a cutout in communication with the receiving slot. The cushion pad includes a clasp block including a connecting portion and an engaging portion. The connecting portion is received in the receiving slot and the engaging portion is inserted through the cutout. The connecting portion slides in the receiving slot to misalign the engaging portion to the cutout and have the engaging portion engaging on the bottom plate.

### BACKGROUND

1. Technical Field

The present disclosure relates to an enclosure of electronic device with a cushion pad.

2. Description of Related Art

Electronic devices such as notebooks are usually positioned on a platform such as a table when in use. An enclosure of the electronic device directly contacts with the platform when the electronic device is positioned on the platform. A friction between the enclosure and the platform may break the enclosure of the notebook. The direct contact between the enclosure and the platform may also affects heat dissipation of the electronic device.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembled view of an embodiment of an electronic device with cushion pads.

FIG. 2 is an exploded, isometric view of a cushion pad and a bottom plate of the enclosure of FIG. 1.

FIG. 3 is similar to FIG. 2, but viewed from another aspect.

FIG. 4 is a partially assembled view of the cushion pad and the bottom plate of FIG. 2.

FIG. 5 is an assembled view of the cushion pad and the bottom plate of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

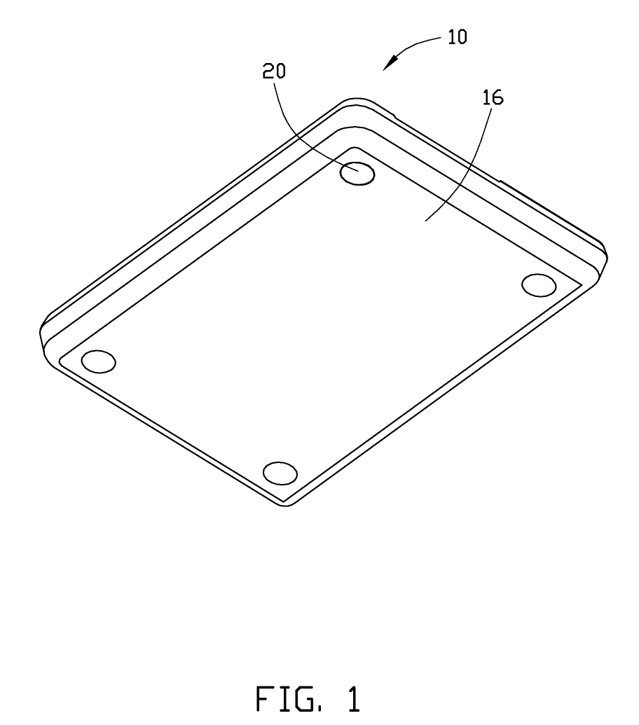

FIG. 1 illustrates an embodiment of an enclosure of an electronic device. The electronic device includes a case 10 and four cushion pads 20 mounted on the case 10.

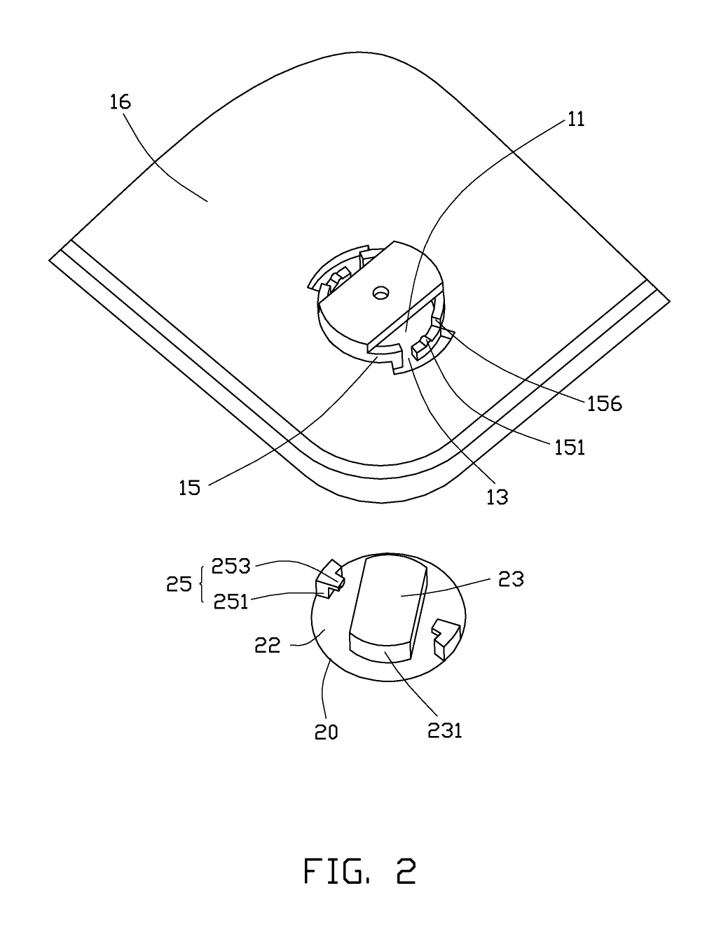

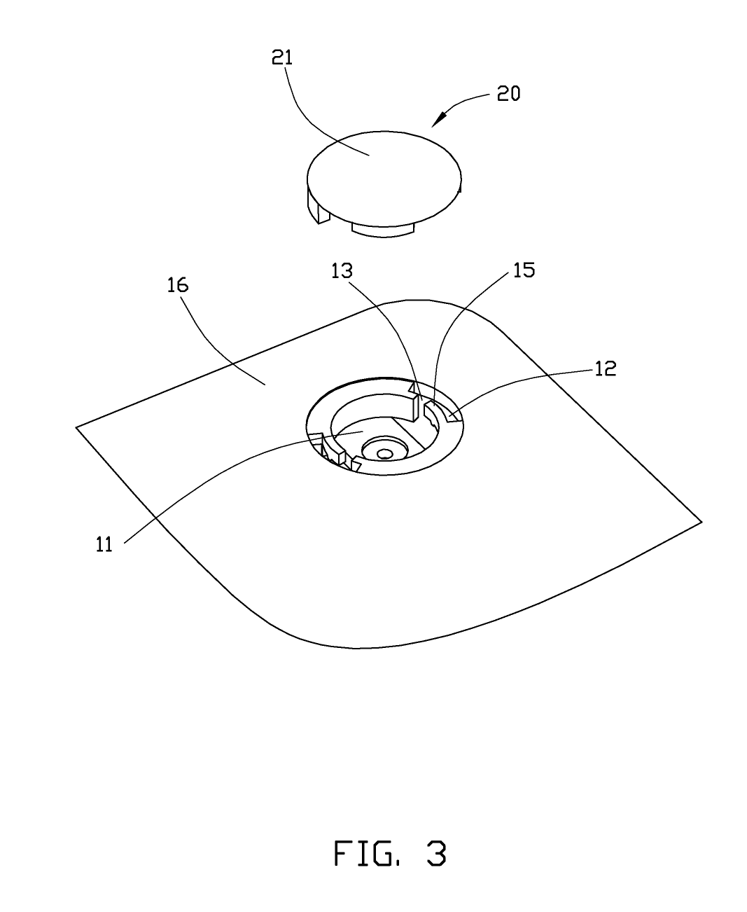

FIGS. 1 to 3 show that the case 10 includes a bottom plate 16. Four corners of the bottom plate 16 define four through holes 11. A strip 15 protrudes from an inner side of the bottom plate 16 and around a ring of each through hole 11. A pair of receiving slots 12 is defined in the bottom plate 16 and communicates with the strip 15. The pair of receiving slots 12 is symmetric about the through hole 11. The strip 15 defines a cutout 13 corresponding to each of the receiving slots 12. The cutout 13 communicates the receiving slot 12 to the through hole 11. A protrusion 151 is formed on the strip 15. The protrusion 151 is adjacent to the cutout 13. The strip 15 defines a stopping edge 156 adjacent the protrusion 151. The protrusion 151 is located between the cutout 13 and the stopping edge 156.

The cushion pad 20 includes a supporting side 21 and an inner side 22 opposite to the supporting side 21. The supporting side 21 is an arc formed surface and made of elastic material. A receiving block 23 is formed on a center portion of the inner side 22. Opposite sides of the receiving block 23 is a pair of engaging surface 231. The engaging surface 231 is an arc surface. A pair of clasp blocks 25 is symmetrically formed on the inner side 22. Each of the clasp block 25 includes a connecting portion 251 and an engaging portion 253. The connecting portion 251 is connected to the inner side 22. The engaging portion 253 protrudes from the connecting portion 251 and towards another clasp block 25. A width of the connecting portion 251 is smaller than a width of the receiving slot 12. A width of the engaging portion 253 is smaller than a width of the cutout 13.

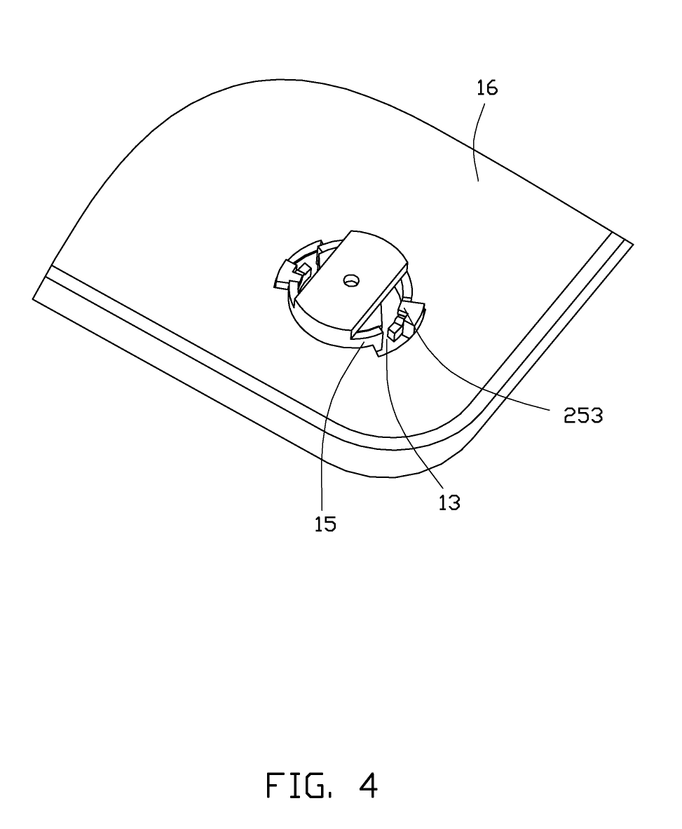

FIGS. 1 to 4 show that in assembly, the engaging portion 253 of the cushion pad 20 is aligned to the cutout 13 of the bottom plate 16. The cushion pad 20 is moved to have the connecting portion 251 inserted in the receiving slot 12. Simultaneously, the engaging portion 253 extends through the cutout 13. The receiving block 23 is received in the through hole 11 with the engaging surface 231 smoothly abutting edges of the through hole 11. Then, the cushion pad 20 rotates in the through hole 11. The engaging surface 231 slides along edges of the through hole 11. The connecting portion 251 of the cushion pad slides in the receiving slot 12. The engaging portion 253 slides on the strip 15 and in succession slides over the protrusion 151 to be stopped by the stopping edge 156. At this position, the engaging portion 253 is misaligned to the cutout 13. Therefore, the cushion pad 20 is mounted on the bottom plate 16. The protrusion 151 prevents the engaging portion 253 from sliding back freely. Therefore, the cushion pad 20 can not detached freely from the bottom plate 16.

Then, the case 10 can be supported on a platform by the cushion pads 20. The supporting sides 21 of the cushion pads 20 generate large friction on the platform to prevent the case 10 form sliding on the platform. Further, the cushion pads 20 increase a heat dissipation space between the case 10 and the platform. Therefore, a heat dissipation efficiency of the case 10 is improved.

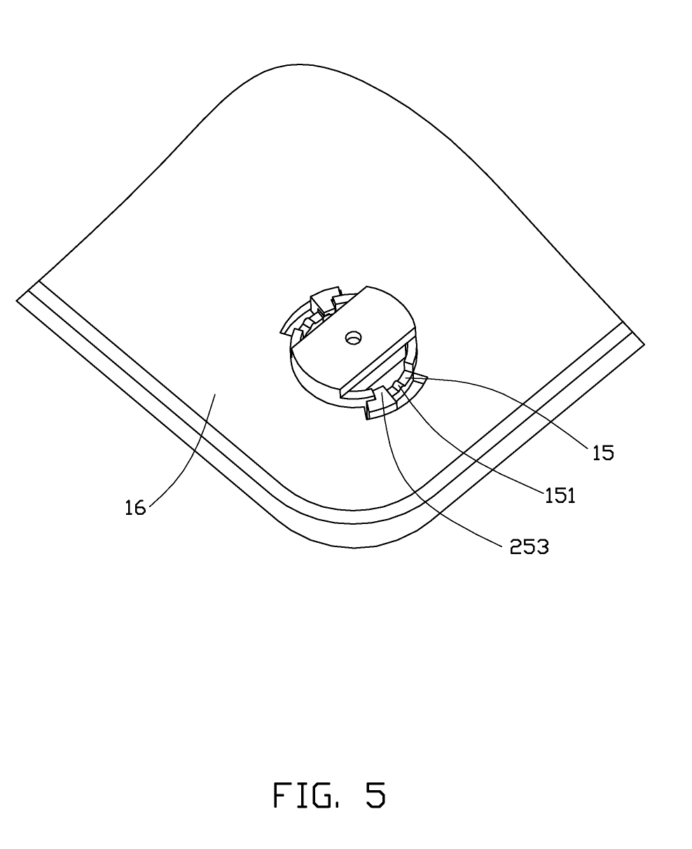

FIG. 5 shows that when the cushion pad 20 needs to be detached from the bottom plate 16, the cushion pad 20 rotates backwardly to have the engaging portion 25 sliding over the protrusion 151 and aligned to the cutout 13. Then, the cushion pad 20 can be detached.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An enclosure of an electronic device, comprising:
a case comprising a bottom plate, the bottom plate defining a receiving slot and a cutout in communication with the receiving slot; and
a cushion pad comprising a clasp block, the clasp block comprising a connecting portion and an engaging portion, wherein the connecting portion is received in the receiving slot and the engaging portion is inserted through the cutout, and the connecting portion is configured to slide into the receiving slot to misalign the engaging portion to the cutout and to have the engaging portion engaging on the bottom plate.

2. The enclosure of claim 1, wherein a through hole is defined in the bottom plate, the cushion pad comprises a receiving block, the receiving block is received in the through hole.

3. The enclosure of claim 2, wherein opposite sides of the receiving block defines a pair of arc engaging surfaces, the pair of arc engaging surfaces are configured to slide along an peripheral of the through hole when the connecting portion slides into the receiving slot.

4. The enclosure of claim 2, wherein a strip is attached to a rim of the through hole, the cutout is defined in the strip to communicate the through hole with the receiving slot.

5. The enclosure of claim 4, wherein a protrusion is formed on the strip, and the protrusion is configured to block the engaging portion.

6. The enclosure of claim 5, wherein the strip defines a stopping edge, and the engaging portion is configured to slide over the protrusion and to abut the stopping edge when the connecting portion slides into the receiving slot.

7. The enclosure of claim 1, wherein the cushion pad comprises an inner side, the connecting portion is connected to the inner side, and the engaging portion is protruded on the connecting portion.

8. The enclosure of claim 7, wherein the cushion pad further comprises a supporting side opposite to the inner side, the supporting side defines an arc-shaped surface and is made of elastic material.

9. An enclosure, comprising:
a case comprising a bottom plate, a strip formed on the bottom plate, the bottom plate defining a receiving slot adjacent to the strip, the strip defining a cutout in communication with the receiving slot, and a protrusion formed on the strip; and
a cushion pad comprising a clasp block, the clasp block comprising a connecting portion and an engaging portion, wherein the connecting portion is received in the receiving slot and the engaging portion is inserted through the cutout, and the connecting portion is configured to slide into the receiving slot to misalign the engaging portion to the cutout and to have the engaging portion sliding over the protrusion to engage on the bottom plate.

10. The enclosure of claim 9, wherein a through hole is defined in the bottom plate, the ring is attached to a rim of the through hole, the cushion pad comprises a receiving block, the receiving block is received in the through hole.

11. The enclosure of claim 10, wherein opposite sides of the receiving block defines a pair of arc engaging surfaces, the pair of arc engaging surfaces are configured to slide along an peripheral of the through hole when the connecting portion slides into the receiving slot.

12. The enclosure of claim 9, wherein the strip defines a stopping edge, and the engaging portion is configured to abut the stopping edge after the engaging portion slides over the protrusion.

13. The enclosure of claim 9, wherein the cushion pad comprises an inner side, the connecting portion is connected to the inner side, and the engaging portion is protruded on the connecting portion.

14. The enclosure of claim 9, wherein the cushion pad further comprises a supporting side opposite to the inner side, the supporting side defines an arc-shaped surface and is made of elastic material.
